(19) United States
(12) Patent Application Publication
(10) Pub. No.: US 2014/0368963 A1
(43) Pub. Date: Dec. 18, 2014

(54) ELECTRO STATIC DISCHARGE PROTECTION DEVICE

(71) Applicant: TDK CORPORATION, Tokyo (JP)

(72) Inventors: Shingo Suzuki, Tokyo (JP); Kensaku Asakura, Tokyo (JP); Takahiro Fujimori, Tokyo (JP)

(73) Assignee: TDK Corporation, Tokyo (JP)

(21) Appl. No.: 14/374,047

(22) PCT Filed: Jan. 22, 2013
(86) PCT No.: PCT/JP2013/051113

§ 371 Date: Jul. 23, 2014

(30) Foreign Application Priority Data
Jan. 27, 2012 (JP) 2012-015476
Jan. 15, 2013 (JP) 2013-004471

(51) Int. Cl. H05F 3/04

(52) U.S. Cl. CPC H05F 3/04
USPC 361/220

(57) ABSTRACT

An ESD countermeasure device is provided with (i) discharge electrodes that are positioned between first and second insulating substrates and are opposite to each other with a gap therebetween; and (ii) a discharge inducing portion that is disposed at opposing portions of the discharge electrodes and between the opposing portions, wherein a cross-sectional area of each of the opposing portions of the discharge electrodes that are opposite to each other is larger than that of each of lead portions of the discharge electrodes that are opposite to each other.

### TECHNICAL FIELD

This invention relates to an electro static discharge (ESD) protection device, and particularly to an ESD protection device that is useful to use in a high-speed transmission system, or in multiplexing with a common mode filter.

### TECHNICAL BACKGROUND

In recent years, rapid progress has been made in size reduction and efficiency improvement of electronic devices. Additionally, as represented by high-speed transmission systems such as USB2.0, S-ATA2, HDMI, or the like, progress in the increase of transmission speeds (high frequency, which exceeds 1 GHz) and reduction of driving voltage has been significant. On the other hand, as the size of electronic devices has been made smaller and the driving voltage has been reduced, a breakdown voltage of electronic components which are used for electronic devices deteriorates. Thus, protecting electronic components from an excessive voltage, as represented by an electrostatic pulse generated when a human body contacts a terminal of an electronic device, is an important technical problem.

Conventionally, as a countermeasure against such an electrostatic pulse, a method is used in which a countermeasure device such as a varistor is arranged between (i) a line into which ESD enters and (ii) a ground. However, in recent years, a signal frequency of a signal line has increased, and when stray capacitance of the ESD countermeasure device is large, signal quality deteriorates; thus, in case of a transmission speed of several hundred Mbps or more, a countermeasure device that has low capacitance of 1 pF or lower is required. Additionally, for an antenna circuit and an RF module of a communication device such as a portable telephone or the like, an electrostatic protective component with capacitance smaller than approximately 0.1 pF is required.

Meanwhile, as an ESD countermeasure device with low capacitance, a device has been proposed in which an ESD protective material is filled between electrodes opposite to each other.

### PRIOR ART REFERENCE

### Patent Reference

Patent Reference 1: Japanese Patent 4571164

### SUMMARY OF THE INVENTION

### Problem to be Resolved by the Invention

In an ESD countermeasure device of Patent Reference 1, inorganic glass and conductive particles or semiconductive particles are filled in a gap between electrodes. However, due to frequency increase in circuits in recent years, lower capacitance is required. In the ESD countermeasure device of Patent Reference 1, capacitance is reduced by adjusting an area at which internal electrodes overlap with each other. However, for the ESD countermeasure device of Patent Reference 1, a tunnel effect was used, a peak voltage was high, and an ESD protective effect was not sufficient.

As a result of extensive studies by the inventors of this invention, it was discovered that in the case of a gap-type ESD countermeasure device that has an excellent protective effect against static electricity with a low peak voltage, not only capacitance, but also electric discharge durability, are affected as the area at which internal electrodes are overlapped with each other is adjusted. That is, in case of a gap-type ESD countermeasure device, an excessive voltage is applied and discharge is generated, which produces the static-electricity suppressing effect. Because of this discharge, opposite electrode portions at the location at which the discharge has occurred are degenerated, and a gap length increases. If discharge testing is repeated, part of the discharge electrode end portion is degenerated in a direction of a terminal portion, so a cross-sectional area of a shortest gap portion is reduced. Because of this, the number of dischargeable locations reduces, and consequently, discharge is also generated at a location at which the gap distance has increased, so the peak voltage increases.

This invention reflects on the above-mentioned situation. An object of this invention is to provide an ESD countermeasure device with small capacitance, a low discharge start voltage, a low peak voltage, and excellent electric discharge durability.

In order to solve the above-described problem, as a result of extensive studies by the inventors, this invention was completed by providing an ESD countermeasure device with the following structure, which resolves the problem.

This invention is an ESD countermeasure device provided with (i) discharge electrodes that are positioned between first and second insulating substrates and are opposite to each other with a gap there between and (ii) a discharge inducing portion that is disposed at opposing portions of the discharge electrodes and between the opposing portions, wherein a cross-sectional area of each of the opposing portions of the discharge electrodes that are opposite to each other is larger than that of each of lead portions of the discharge electrodes that are opposite to each other.

That is, parasitic capacitance is also generated in a surrounding area of the electrodes of the lead portions other than the area at which the opposite electrodes are overlapped with each other. Thus, if the cross-sectional area (width and thickness) of each of the lead portions is reduced, capacitance can be suppressed. By reducing the cross-sectional area of the opposite portions that are opposite to each other as well, the capacitance can be suppressed, but this method contributes to deterioration of electric discharge durability, and so is not preferable. Additionally, a flowing current when an ESD countermeasure device of this invention is operated is at most approximately 10 mA or lower, so there is no need for a cross-sectional area such as is used for a conventional varistor.

A “cross-sectional area of each of the opposite portions” of this invention refers to a maximum cross-sectional area, cut perpendicularly to a longitudinal direction of the ESD countermeasure device, of the portions of the ESD countermeasure device that are formed from (i) a tip end of each of the opposite portions to (ii) positions that are shifted, by the gap distance, toward the lead portion sides along the longitudinal direction.

Additionally, a “cross-sectional area of each of the lead portions” of this invention refers to a cross-sectional area, cut perpendicularly to a longitudinal direction of the ESD countermeasure device, of the portions of the ESD countermeasure device that are formed from (i) the tip end portion of each of the discharge electrodes to (ii) positions that are shifted five times the gap distance toward the lead electrode sides along the longitudinal direction.

With respect to the cross-sectional area of each of the opposite portions of the discharge electrodes that are arranged opposite to each other, it is preferable to obtain a structure in which a cross-sectional area ratio of each of the lead portions is in a range of from 6% to 80%. Upon considering a peak voltage, it is more preferable to obtain a structure in which a cross-sectional area ratio of each of the lead portions is in a range of from 10% to 80%. By obtaining this structure, the capacitance can be reduced without affecting other electrical characteristics such as electric discharge durability. Furthermore, the cross-sectional area ratio of each of the opposite electrodes is (i) the cross-sectional area of each of the lead portions divided by (ii) the cross-sectional area of each of the opposite portions.

A thickness of each of the discharge electrodes that are opposite to each other can be appropriately set, and is not particularly limited, but is usually in a range of from approximately 0.1 μm to approximately 20 μm. Furthermore, a width of a main surface of each of the discharge electrodes can be approximately set as well, and is not particularly limited, but is usually in a range of from approximately 50 μm to approximately 500 μm. With respect to the cross-sectional area of each of the opposite portions of the discharge electrodes that are opposite to each other, it is preferable that the cross-sectional area ratio of each the lead portions is appropriately set so as to obtain a structure within the above ranges.

Upon considering a desired discharge characteristic, the gap distance between the discharge electrodes that are opposite to each other can be appropriately set. It is usually within a range of from approximately 0.1 μm to approximately 50 μm. In view of reducing a peak voltage, a preferable range of the distance between the opposite electrodes is from approximately 5 μm to approximately 40 μm.

These inventors measured a characteristic of the thus-constituted ESD countermeasure device and discovered that the capacitance of the ESD countermeasure device was reduced compared to the capacitance of a conventional ESD countermeasure device. Details of the operation mechanism with such an effect are not yet clear, but the following shows the inventors' assumptions.

In a gap-type ESD countermeasure device, usually, a cross-sectional shape of each of the opposite portions of the discharge electrodes is maintained as-is, is extended to a base portion external side, and is connected to an external electrode. According to this invention, by reducing a cross-sectional area (width and/or thickness) of each of the lead portions compared to the opposite portions of the electrode portions that are opposite to each other, capacitance is consequently reduced.

Furthermore, parasitic capacitance is also generated in a surrounding area of the electrodes of the lead portions other than the area in which the opposite electrodes are overlapped with each other. Thus, if the cross-sectional area (width and/or thickness) of each of the lead portions is reduced, capacitance can be suppressed. In discharge testing that is repeated, discharge parts of the opposite electrodes are degenerated, and the gap length increases. However, according to this invention, by making the cross-sectional area of each of the opposite portions of the discharge electrodes that are opposite to each other larger than the cross-sectional area of the lead portions of the discharge electrodes that are opposite to each other, even if discharge testing is repeated, a peak voltage is maintained.

### Effects of the Invention

According to this invention, an ESD countermeasure device can be realized in which capacitance is reduced, and which has a low discharge start voltage and a low peak voltage. Compared to cases in which a varistor or a Zener diode is used for ESD protection, this invention can make the capacitance of an ESD protective portion (discharge inducing portion) extremely small. Furthermore, compared to a conventional gap-type device, the capacitance can be made much smaller. Thus, an ESD protective function can be sufficiently manifested in a high frequency circuit.

### BRIEF DESCRIPTION OF THE DRAWINGS

FIG. 1 is a cross-sectional view schematically showing an ESD countermeasure device 100.

FIG. 2 is a schematic perspective view of a manufacturing step of the ESD countermeasure device 100.

FIG. 3 is a schematic perspective view of a manufacturing step of the ESD countermeasure device 100.

FIG. 4 is a schematic perspective view of a manufacturing step of the ESD countermeasure device 100.

FIG. 5 is a schematic perspective view of a manufacturing step of the ESD countermeasure device 100.

FIG. 6 is a circuit diagram for ESD testing.

### MODE TO IMPLEMENT THE INVENTION

The following explains a mode to implement this invention. Additionally, the same symbols are used for the same devices, and any duplicate explanations are omitted herein. Furthermore, position relationships such as up, down, right, and left are based on the position relationships shown in the drawings unless otherwise specified. In addition, dimension ratios of the drawings are not limited to the depicted ratios. Also, the following mode is an example to explain this invention, and this invention is not limited to the mode only.

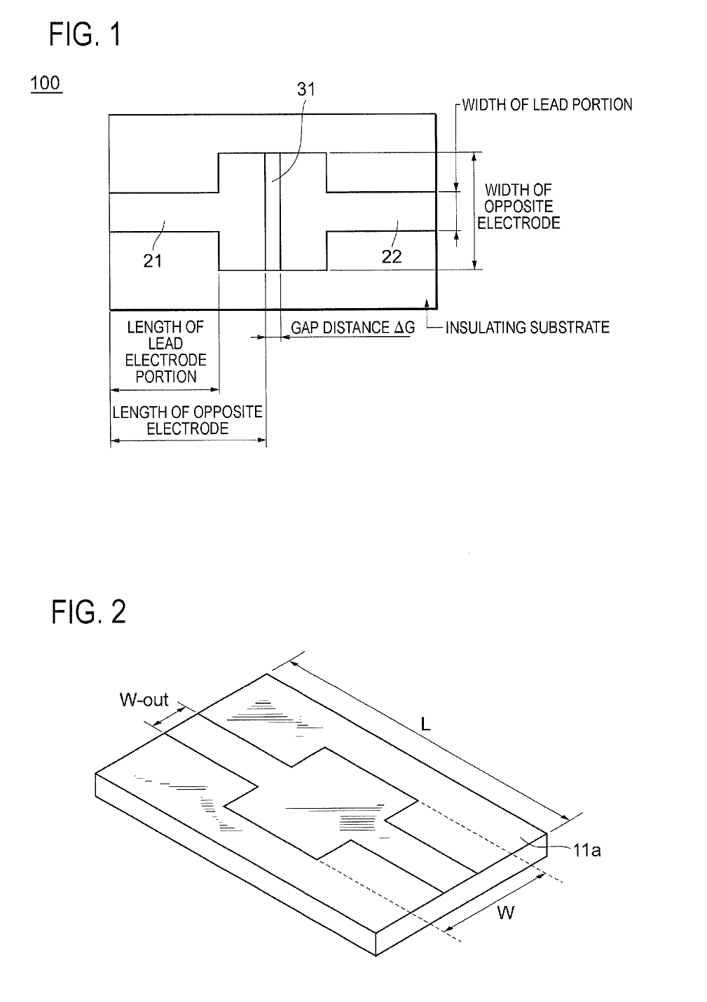

FIG. 1 is a cross-sectional view schematically showing an ESD countermeasure device of this mode.

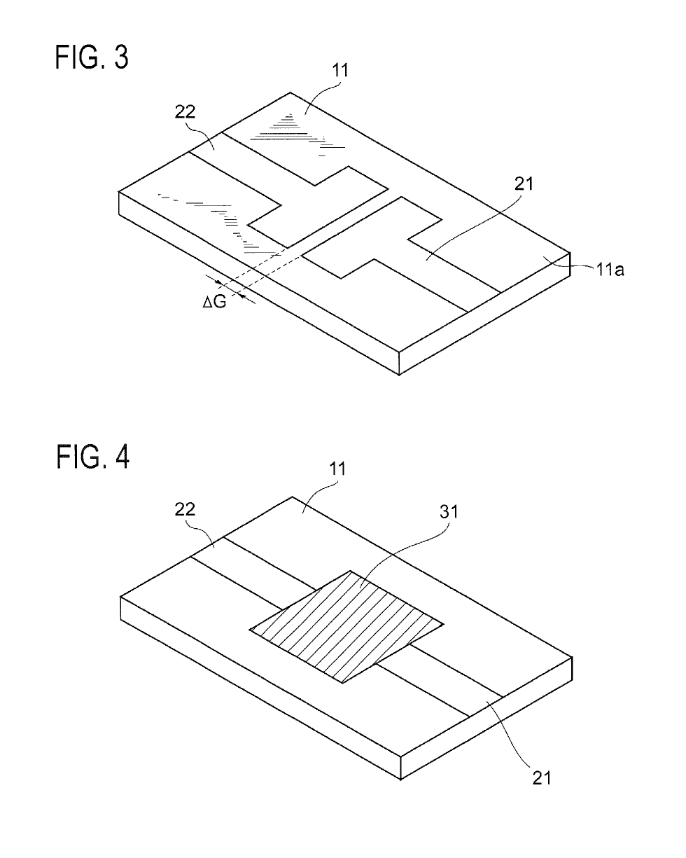

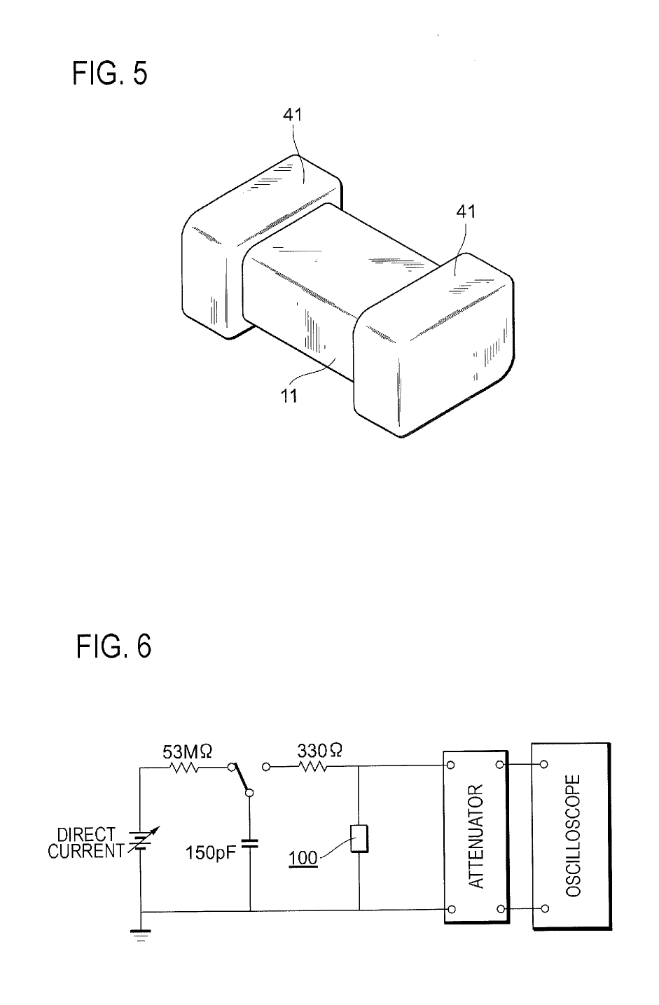

An ESD countermeasure device 100 is provided with (i) a first insulating substrate 11 (see FIG. 3), (ii) a pair of discharge electrodes 21, 22 disposed on this first insulating substrate 11, (iii) a discharge inducing portion 31 that is disposed between the discharge electrodes 21, 22, and (iv) terminal electrodes 41 (see FIG. 5) electrically connected to the discharge electrodes 21, 22. In this ESD countermeasure device 100, the discharge inducing portion 31 functions as a low-voltage discharge-type ESD protective material and is designed such that when an excessive voltage such as ESD is applied, discharge is generated between the discharge electrodes 21, 22 via the discharge inducing portion 31, and the ESD is guided to a ground. Additionally, this ESD countermeasure device 100 is formed by layered construction and is used in a state in which upper and lower surfaces of the pair of discharge electrodes 21, 22 are coated by an insulating material. Because of this, on the discharge inducing portion 31, a protective layer is formed, which is formed so as to cover the discharge inducing portion 31 and is formed of a second insulating substrate (undepicted).

The first insulating substrate 11 has an insulating surface 11a (FIG. 3). A dimensional shape of the first insulating substrate 11 is not particularly limited as long as it can support at least the discharge electrodes 21, 22 and the discharge inducing portion 31. Here, the first insulating substrate 11 having the insulating surface 11a is a concept including substrates in which an insulating film being manufactured on part of or an entire surface of a substrate, in addition to substrates formed of an insulating material.

As specific examples of the first insulating substrate 11, ceramic substrates, single-crystal substrate, or the like can be listed, in which is used a low-dielectric-constant material, having a dielectric constant of 50 or lower, and preferably 20 or lower, for example, aluminum, silica, magnesia, aluminum nitride, forsterite, or the like. Additionally, it is also possible to suitably use substrates in which an insulating film formed of a low-dielectric-constant material, having a dielectric constant of 50 or lower, and preferably 20 or lower, for example, aluminum, silica, magnesia, aluminum nitride, forsterite, or the like, is formed on the surface of a ceramic substrate, a single-crystal substrate, or the like.

On the insulating surface 11a of the first insulating substrate 11, the pair of discharge electrodes 21, 22 is arranged, with the discharge electrodes 21, 22 separated from each other. In this mode, the discharge electrodes 21, 22 are arranged opposite to each other at a gap distance AG at substantially the center position, in plan view, of the first insulating substrate 11. Here, the gap distance AG refers to the shortest distance between the pair of discharge electrodes 21, 22.

As a material that constitutes the discharge electrodes 21, 22, at least one type of metal selected from among, for example, C, Ni, Al, Fe, Cu, Ti, Cr, Au, Ag, Pd, and Pt, or alloys of these, can be listed, but it is not particularly limited to these. Additionally, in this mode, the discharge electrodes 21, 22 are formed to be rectangular in plan view, but the shape is not particularly limited to this. For example, they can also be formed in a comb tooth shape or a saw tooth shape.

The gap distance AG between the discharge electrodes 21, 22 can be appropriately set upon considering a desired discharge characteristic, and is not particularly limited. However, it is usually within a range of from approximately 1 μm to approximately 50 μm. From the standpoint of securing a low-voltage initial discharge, it is preferably in a range of from approximately 5 μm to approximately 40 μm, and more preferably in a range of from approximately 10 μm to approximately 30 μm. Additionally, a thickness of each of the discharge electrodes 21, 22 can be appropriately set and is not particularly limited, but it is usually in a range of from approximately 1 μm to approximately 20 μm.

As for a method of forming the discharge electrodes 21, 22, after coating a precursor of a metal or an alloy, for example, an electrode paste, a gap portion of the discharge electrodes 21, 22 can be formed by laser processing or the like. A gap formation laser is not particularly limited, but can be appropriately selected. Specifically, for example, a femtosecond laser, a UV laser, a CO2 laser, or the like can be listed.

The discharge inducing portion 31 is arranged between the discharge electrodes 21, 22. In this mode, a structure is constituted such that a discharge inducing material of the discharge inducing portion 31 is laminated on the insulating surface 11a of the first insulating substrate 11 and on part of the discharge electrodes 21, 22. The dimensional shape and the arrangement position of the discharge inducing portion 31 are not particularly limited as long as it is designed such that an initial discharge is secured through the discharge inducing portion 31 between the discharge electrodes 21, 22 when an excessive voltage is applied.

A discharge inducing member formed in the discharge inducing portion 31 is a composite in which conductive inorganic materials are discontinuously (uniformly or randomly) dispersed, within a matrix of the insulating inorganic material. In other words, the discharge inducing member formed in the discharge inducing portion 31 is a member in which conductive inorganic materials are discontinuously dotted in a matrix of the insulating inorganic material.

As specific examples of the insulating inorganic material comprising the matrix, for example, metal oxide, composite oxide such as forsterite, or metal nitride, metal carbide, or the like can be listed, but it is not limited to these. Upon considering insulating properties and costs, Al₂O₃, SrO, CaO, BaO, TiO₂, SiO₂, ZnO, In₂O₃, NiO, CoO, SnO₂, V₂O₅, CuO, MgO, and ZrO₂ are preferable for metal oxide, AIN and BN are preferable for metal nitride, and SiC is preferable for metal carbide. One type of these can be individually used, or two types or more can be combined and used. A matrix of the insulating inorganic material can be formed as a uniform film of the insulating inorganic material or can be formed as an aggregate of particles of the insulating inorganic material. The shape is not particularly limited. Among these, from the standpoint of imparting an insulating property to the insulating matrix, it is more preferable to use Al₂O₃, SrO₂, forsterite, or the like. Meanwhile, from the standpoint of imparting a semiconductor property to the insulating matrix, it is more preferable to use TiO₂ or ZnO. By imparting an insulating property to the insulating matrix, an ESD countermeasure device with a low discharge start voltage and a low clamp voltage can be obtained.

As specific examples of the conductive inorganic material, for example, a metal, an alloy, a metal oxide, a metal nitride, metal carbide, a metal boride, or the like can be listed, but it is not particularly limited to these. Upon considering conductivity, C, Ni, Al, Fe, Cu, Ti, Cr, Au Ag, Pd, and Pt, or an alloy of these is preferable.

This is an ESD countermeasure device provided with (i) discharge electrodes that are positioned between first and second insulating substrates and are opposite to each other with a gap therebetween and (ii) a discharge inducing portion that is disposed at opposing portions of the discharge electrodes and between the opposing portions, wherein the opposite portions of the discharge electrodes are defined as the length five times the gap distance from tip ends of the opposite portions to the terminal electrodes, and sides of the terminal electrodes are used as lead portions. As for the discharge electrodes that are opposite to each other, a structure is preferable in which the cross-sectional area ratio of each of the lead portions is in a range of from 6% to 80%, compared to the cross-sectional area of each the opposite portions. Upon considering a peak voltage, a structure is more preferable in which the cross-sectional area ratio of each of the lead portions is in a range of from 10% to 80%. By obtaining this structure, capacitance can be reduced without affecting other electrical characteristics such as a discharge start voltage.

A thickness of the discharge inducing portion 31 is not particularly limited, and can be appropriately set, but the thickness is preferably in a range of from 10 nm to the thickness of the device. It is more preferably in a range of from 1 μm to a half the thickness of the device.

In the ESD countermeasure device 100 of this mode, the discharge inducing portion 31 formed of a discharge inducing member that is a composite in which conductive inorganic materials are discontinuously dispersed in a matrix of the insulating inorganic material functions as a low-voltage discharge-type ESD protective material. Additionally, by reducing a width (thickness) of each of the lead portions of the discharge electrodes, the ESD countermeasure device 100 with a high performance capability can be realized, in which capacitance is reduced.

The discharge electrodes 21, 22 are not necessarily formed on the same plane. It is desirable that they are formed so as to maintain a structure in which the discharge electrodes are opposite to each other.

### EMBODIMENTS

The following explains details of this invention, using embodiments, but this invention is not limited to these embodiments.

### Embodiment 1

First, as shown in FIG. 2, as an insulating substrate 11, a green sheet was prepared in which a material whose main components are Al₂O₃ and glass is made into a sheet. On one insulating surface 11a, Ag paste was printed by screen printing, and a cross-shaped electrode pattern was formed. The electrode shape was such that, after firing, a length (L) was 1 mm, a width (W) was 0.16 mm, and an outside portion (W-out) was 0.08 mm. Furthermore, in order to adjust a thickness of discharge electrodes that are opposite to each other, a thickness specification of platemaking was appropriately selected and printing was performed such that, after firing, a thickness of the discharge electrodes became 10 μm. By so doing, in the ESD countermeasure device of embodiment 1, a width of each of the electrodes at the center portion of the discharge electrodes is different from that at each of the electrodes at the so-called lead electrode portions that extend to device end portions, so the cross-sectional area of each of the electrodes varies.

Next, as shown in FIG. 3, at the center of the cross-shaped electrode pattern, gap processing was performed using a femtosecond laser such that the gap distance became 10 μm after firing.

Next, as shown in FIG. 4, according to the following procedure, the discharge inducing portion 31 was formed on the first insulating substrate 11 and the discharge electrodes 21, 22.

First, a mixture was obtained by measuring and mixing (i) 80 vol % of glass particles (manufactured by Nihon Yamamura Glass Co., Ltd.: product number—ME 13) in which SiO₂ as an insulating inorganic material is a main component, and (ii) 20 vol % of Ag particles (manufactured by MITSUI MINING & SMELTING CO., LTD.: product number—SPQ03R), in which an average particle diameter is 0.5 μm, as a conductive inorganic material. Separately, lacquer whose solid content concentration is 8 weight % was prepared by kneading (i) an ethyl cellulose-based resin as a binder and (ii) terpineol as a solvent. Next, after the lacquer was added to the mixture of the insulating inorganic material and the conductive inorganic material that was prepared as described above, a paste mixture was prepared by kneading the mixture.

Next, the obtained paste mixture was coated by screen printing so as to cover the insulating surface 11a (FIG. 4) of the first insulating substrate 11 and the discharge electrodes 21, 22, and a mixture layer (precursor of the discharge inducing member that forms the discharge inducing portion 31) was formed. Additionally, after a green sheet to become the second insulating substrate was laminated on the mixture layer, a laminate was manufactured by hot pressing. Then, the obtained laminate was cut into pieces of a specific size. After that, the temperature was caused to be increased by 10° C. every minute, and it was maintained and fired for 30 minutes in a condition in which the atmosphere was 950° C.

After that, as shown in FIG. 5, the ESD countermeasure device 100 of embodiment 1 was obtained by forming the terminal electrodes 41, in which Ag is a main component, so as to connect to outer circumferential terminal portions of the discharge electrodes 21, 22.

### Embodiment 2

Only a center portion of a cross-shaped electrode pattern was pattern-formed, and lead electrode portions that lead to a device terminal portion were separately printed and formed so as to have varying thicknesses. First, regarding the shape to be printed as the center portion of the cross-shaped electrode pattern, the width (corresponding to W of FIG. 2) was made to become 0.16 mm after firing, and in order to adjust the thickness of the opposing discharge electrodes, a thickness specification of platemaking was appropriately selected, and printing was performed such that the thickness of the discharge electrodes after firing became 20 μm. Next, an electrode pattern was formed that was connected to the center portion of the cross-shaped electrode pattern, and extended to the device terminal portions on both sides. The electrode pattern that extended to the printed device terminal portion was constituted such that its width (corresponding to W-out of FIG. 2) became 0.08 mm. Additionally, in order to adjust the thickness of the electrode pattern that extended to the device terminal portion, a thickness specification of platemaking was appropriately selected, and printing was performed such that the thickness of the electrode pattern that extended to the device terminal portion became 10 μm after firing. Other than that, by operating in the same manner as for embodiment 1, the ESD countermeasure device 100 of embodiment 2 was obtained. By so doing, in the ESD countermeasure device of embodiment 2, a cross-sectional area of the electrode varies because the electrode width and thickness are different in (i) the center portion of the discharge electrodes and (ii) the so-called lead electrode portions that extend to the device terminal portions.

### Embodiment 3

A belt-shaped electrode pattern was pattern-formed in only a center portion of a device. Regarding the belt-shaped electrode pattern to be printed, the width (corresponding to W of embodiment 1) was made to become 0.16 mm after firing, and in order to adjust the thickness of the opposing discharge electrodes that are formed by the belt-shaped electrode pattern, a thickness specification of platemaking was appropriately selected, and printing was performed such that the thickness of the discharge electrodes after firing became 20 μm. Next, an electrode pattern was formed that was connected to the belt-shaped electrode, and extended to the device terminal portions on both sides. The electrode pattern that extended to the printed device terminal portion was constituted such that its width (corresponding to W-out of embodiment 1) became 0.16 mm, which is the same as the width of the belt-shaped electrode pattern. Additionally, in order to adjust the thickness of the electrode pattern that extended to the device terminal portion, a thickness specification of platemaking was appropriately selected, and printing was performed such that the thickness of the electrode pattern that extended to the device terminal portion became 10 μm after firing. Other than that, by operating in the same manner as for embodiment 1, the ESD countermeasure device 100 of embodiment 3 was obtained. By so doing, in the ESD countermeasure device of embodiment 3, a cross-sectional area of the electrode varies because only the electrode thickness is different in (i) the center portion of the discharge electrodes and (ii) the so-called lead electrode portions that extend to the device terminal portions.

### Embodiment 4

A belt-shaped electrode pattern was pattern-formed in only a center portion of a device. Regarding the belt-shaped electrode pattern to be printed, the width (corresponding to W of embodiment 1) was made to become 0.16 mm after firing, and in order to adjust the thickness of the opposing discharge electrodes that are formed by the belt-shaped electrode pattern, a thickness specification of platemaking was appropriately selected, and printing was performed such that the thickness of the discharge electrodes after firing became 20 μm. Next, an electrode pattern was formed that was connected to the belt-shaped electrode, and extended to the device terminal portions on both sides. The electrode pattern that extended to the printed device terminal portion was constituted such that its width (corresponding to W-out of embodiment 1) became 0.16 mm, which is the same as the width of the belt-shaped electrode pattern. Additionally, in order to adjust the thickness of the electrode pattern that extended to the device terminal portion, a thickness specification of platemaking was appropriately selected, and printing was performed such that the thickness of the electrode pattern that extended to the device terminal portion became 14 μm after firing. Other than that, by operating in the same manner as for embodiment 1, the ESD countermeasure device 100 of embodiment 4 was obtained. By so doing, in the ESD countermeasure device of embodiment 4, a cross-sectional area of the electrode varies because only the electrode thickness is different in (i) the center portion of the discharge electrodes and (ii) the so-called lead electrode portions that extend to the device terminal portions.

### Embodiment 5

A belt-shaped electrode pattern was pattern-formed in only a center portion of a device. Regarding the belt-shaped electrode pattern to be printed, the width (corresponding to W of embodiment 1) was made to become 0.16 mm after firing, and in order to adjust the thickness of the opposing discharge electrodes that are formed by the belt-shaped electrode pattern, a thickness specification of platemaking was appropriately selected, and printing was performed such that the thickness of the discharge electrodes after firing became 20 μm. Next, an electrode pattern was formed that was connected to the belt-shaped electrode, and extended to the device terminal portions on both sides. The electrode pattern that extended to the printed device terminal portion was constituted such that its width (corresponding to W-out of embodiment 1) became 0.16 mm, which is the same as the width of the belt-shaped electrode pattern. Additionally, in order to adjust the thickness of the electrode pattern that extended to the device terminal portion, a thickness specification of platemaking was appropriately selected, and printing was performed such that the thickness of the electrode pattern that extended to the device terminal portion became 16 μm after firing. Other than that, by operating in the same manner as for embodiment 1, the ESD countermeasure device 100 of embodiment 5 was obtained. By so doing, in the ESD countermeasure device of embodiment 5, a cross-sectional area of the electrode varies because only the electrode thickness is different in (i) the center portion of the discharge electrodes and (ii) the so-called lead electrode portions that extend to the device terminal portions.

### Embodiment 6

Only a center portion of a cross-shaped electrode pattern was pattern-formed, and lead electrode portions that lead to a device terminal portion were separately printed and formed so as to have different thicknesses. First, regarding the shape to be printed as the center portion of the cross-shaped electrode pattern, the width (corresponding to W of FIG. 2) was made to become 0.16 mm after firing, and in order to adjust the thickness of the opposing discharge electrodes, a thickness specification of platemaking was appropriately selected, and printing was performed such that the thickness of the discharge electrodes after firing became 20 μm. Next, an electrode pattern was formed that was connected to the center portion of the cross-shaped electrode pattern, and extended to the device terminal portions on both sides. The electrode pattern that extended to the printed device terminal portion was constituted such that its width (corresponding to W-out of FIG. 2) became 0.08 mm. Additionally, in order to adjust the thickness of the electrode pattern that extended to the device terminal portion, a thickness specification of platemaking was appropriately selected, and printing was performed such that the thickness of the electrode pattern that extended to the device terminal portion became 2 μm after firing. Other than that, by operating in the same manner as for embodiment 1, the ESD countermeasure device 100 of embodiment 6 was obtained. By so doing, in the ESD countermeasure device of embodiment 6, a cross-sectional area of the electrode varies because the electrode width and thickness are different in (i) the center portion of the discharge electrodes and (ii) the so-called lead electrode portions that extend to the device terminal portions.

### Embodiment 7

Only a center portion of a cross-shaped electrode pattern was pattern-formed, and lead electrode portions that lead to a device terminal portion were separately printed and formed so as to have different thicknesses. First, regarding the shape to be printed as the center portion of the cross-shaped electrode pattern, the width (corresponding to W of FIG. 2) was made to become 0.16 mm after firing, and in order to adjust the thickness of the opposing discharge electrodes, a thickness specification of platemaking was appropriately selected, and printing was performed such that the thickness of the discharge electrodes after firing became 20 μm. Next, an electrode pattern was formed that was connected to the center portion of the cross-shaped electrode pattern, and extended to the device terminal portions on both sides. The electrode pattern that extended to the printed device terminal portion was constituted such that its width (corresponding to W-out of FIG. 2) became 0.08 mm. Additionally, in order to adjust the thickness of the electrode pattern that extended to the device terminal portion, a thickness specification of platemaking was appropriately selected, and printing was performed such that the thickness of the electrode pattern that extended to the device terminal portion became 4 μm after firing. Other than that, by operating in the same manner as for embodiment 1, the ESD countermeasure device 100 of embodiment 7 was obtained By so doing, in the ESD countermeasure device of embodiment 7, a cross-sectional area of the electrode varies because the electrode width and thickness are different in (i) the center portion of the discharge electrodes and (ii) the so-called lead electrode portions that extend to the device terminal portions.

### Comparative Example 1

A belt-shaped electrode pattern was pattern-formed on the entire insulating surface. Regarding the printed belt-shaped electrode pattern, the width (corresponding to W=W—out of FIG. 2) was made to become 0.16 mm after firing, and in order to adjust the thickness of the opposing discharge electrodes, a thickness specification of platemaking was appropriately selected, and printing was performed such that the thickness of the discharge electrodes after firing became 20 μm. Other than that, by operating in the same manner as for embodiment 1, the ESD countermeasure device 100 of comparative example 1 was obtained. By so doing, in the ESD countermeasure device of comparative example 1, a cross-sectional area of the electrode is the same because the electrode width and thickness are the same in (i) the center portion of the discharge electrodes and (ii) the so-called lead electrode portions that extend to the device terminal portions.

### Comparative Example 2

A belt-shaped electrode pattern was pattern-formed on the entire insulating surface. Regarding the printed belt-shaped electrode pattern, the width (corresponding to W=W—out of FIG. 2) was made to become 0.08 mm after firing, and in order to adjust the thickness of the opposing discharge electrodes, a thickness specification of platemaking was appropriately selected, and printing was performed such that the thickness of the discharge electrodes after firing became 20 μm. Other than that, by operating in the same manner as for embodiment 1, the ESD countermeasure device 100 of comparative example 2 was obtained. By so doing, in the ESD countermeasure device of comparative example 2, a cross-sectional area of the electrode is the same because the electrode width and thickness are the same in (i) the center portion of the discharge electrodes and (ii) the so-called lead electrode portions that extend to the device terminal portions.

<ESD Testing>

Next, by using the ESD testing circuit shown in FIG. 6, ESD testing was performed for the thus-obtained ESD countermeasure device 100 of embodiments 1-3 [sic. 1-7] and the thus-obtained ESD countermeasure device of comparative examples 1-2. Table 1 shows the testing results. The same discharge testing was repeated 100 times for electric discharge durability.

TABLE 1

| | Cross- | | | | |
|---|---|---|---|---|---|
| | sectional | Initial Characteristics | | | |
| | area ratio | | Discharge | | Peak voltage |
| | (%) of | | start | Peak | after discharge |
| | opposite | Capacitance | voltage | voltage | durability testing |
| | electrodes | Ave.(pF) | Ave.(kV) | Ave.(kv) | Ave.(kv) |
| Embodiment 1 | 50% | 0.11 | 3.1 | 340 | 309 |
| Embodiment 2 | 25% | 0.12 | 2.9 | 378 | 393 |
| Embodiment 3 | 50% | 0.13 | 3.0 | 355 | 386 |
| Embodiment 4 | 70% | 0.14 | 3.1 | 330 | 401 |
| Embodiment 5 | 80% | 0.14 | 2.7 | 318 | 385 |
| Embodiment 6 | 5% | 0.11 | 3.0 | 591 | 802 |
| Embodiment 7 | 10% | 0.11 | 3.2 | 391 | 420 |
| Comparative Example 1 | 100% | 0.15 | 3.0 | 369 | 344 |
| Comparative Example 2 | 100% | 0.12 | 2.8 | 320 | 681 |

This ESD testing was performed in conformance with a human body model (discharge resistance of 330Ω, discharge capacitance of 150 pF, applied voltage of 8 kV, contact discharge), based on the ESD immunity testing of international standard IEC61000-4-2 and noise testing. Specifically, as shown in the electrostatic [discharge] testing circuit of FIG. 6, after one terminal electrode of the ESD countermeasure device to be evaluated was grounded to a ground, and an electrostatic pulse applying portion was connected to the other terminal electrode, a discharge gun was caused to contact the electrostatic pulse applying portion, and an electrostatic pulse was applied. Here, the applied electrostatic pulse applied a voltage greater than or equal to a discharge start voltage or higher.

Furthermore, in an electrostatic absorption waveform that was observed when electrostatic [discharge] testing was performed while the applied voltage was increased at an interval of 0.4 kV to 0.2 kV, the discharge start voltage was considered to be the voltage at which an electrostatic absorption effect had appeared, and the voltage with the highest electrostatic absorption waveform was considered to be the peak voltage. Additionally, the capacitance was capacitance (pF) at 1 MHz.

From the results shown in Table 1, as for the ESD countermeasure devices of embodiments 1-3, it was confirmed that the capacitance was less than 0.15 pF, which was small, and that the devices had high efficiency, and could be applied to high-speed transmission systems. Moreover, as for the ESD countermeasure device of embodiments 1-5 and 7, the peak voltage after discharge durability testing was hardly different from that of the initial characteristic, so it was confirmed that the capacitance was reduced without decreasing discharge durability. Additionally, in embodiment 6, the capacitance was 0.11 pF, which was low, while the peak voltage was high at both the initial characteristic and after discharge durability testing. Meanwhile, in comparative example 1, the capacitance became 0.16 pF, which was large. In comparative example 2, the capacitance was 0.12 pF, which was slightly low, while the peak voltage after discharge durability testing deteriorated.

### POSSIBILITY OF INDUSTRIAL USE

As described above based on the embodiments, the capacitance was reduced by reducing a cross-sectional area of the lead portion of the discharge electrodes, and the ESD countermeasure device of this invention can be widely and effectively used for electronic and electrical devices, and for various devices, equipment, systems, or the like provided with such electronic and electrical devices.

### EXPLANATION OF THE SYMBOLS

11 First insulating substrate
11a Insulating surface
21, 22 Discharge electrodes
31 Discharge inducing portion
32 Insulating inorganic material
41 Terminal electrode
100 ESD countermeasure device
ΔG Gap distance

1. An ESD countermeasure device, comprising:
discharge electrodes that are positioned between first and second insulating substrates and are opposite to each other with a gap therebetween; and
a discharge inducing portion that is disposed at opposing portions of the discharge electrodes and between the opposing portions,
wherein a cross-sectional area of each of the opposing portions of the discharge electrodes that are opposite to each other is larger than that of each of lead portions of the discharge electrodes that are opposite to each other.

2. The ESD countermeasure device as set forth in claim 1,
wherein a thickness of the opposing portion of the discharge electrodes is thicker than that of the lead portions of the discharge electrodes, whereby the cross-sectional area of each of the opposing portions of the discharge electrodes is larger than that of each of lead portions of the discharge electrodes.

3. The ESD countermeasure device as set forth in claim 1,
wherein a width of the opposing portions of the discharge electrodes is larger than that of the lead portions of the discharge electrodes, whereby the cross-sectional area of each of the opposing portions of the discharge electrodes is larger than that of each of the lead portions of the discharge electrodes.

4. The ESD countermeasure device as set forth in claim 1,
wherein a thickness and a width of the opposing portions of the discharge electrodes are larger than those of the lead portions of the discharge electrodes, whereby the cross-sectional area of each of the opposing portions of the discharge electrodes is larger than that of each of the lead portions of the discharge electrodes.
